(19) United States
(12) Patent Application Publication
(10) Pub. No.: US 2024/0081363 A1
(43) Pub. Date: Mar. 14, 2024

(54) CHOCOLATE MAKING UNITS FOR PREPARING PERSONALIZED CHOCOLATE, AND METHODS OF USING SUCH UNITS

(71) Applicant: HOME CHOCOLAT, INC., Brooklyn, NY (US)

(72) Inventor: Liora OMER, Tzur-Yigal (IL)

(21) Appl. No.: 18/041,868

(22) PCT Filed: Aug. 17, 2021
(86) PCT No.: PCT/IL2021/051002

§ 371 Date: Feb. 16, 2023

(30) Foreign Application Priority Data
Aug. 20, 2020 (IL) 276840

(51) Int. Cl. A23G 1/00; A23G 1/36

(52) U.S. Cl. CPC A23G 1/0066; A23G 1/36

(57) ABSTRACT

The present disclosure concerns a chocolate making base unit comprising, refined together, an edible fat selected from cocoa butter and/or cocoa butter alternative and a sweetener, wherein the sweetener is in particulate form, and wherein the chocolate making base unit is free of cocoa solids and milk. This base unit is useful for the production of personalized chocolate products, by mixing the base unit with at least one chocolate making supplementary unit. Also provided herein are methods of producing the base unit and the chocolate product and packages for use in preparing the chocolate product making use of the chocolate making base unit.

### TECHNOLOGICAL FIELD

The present disclosure concerns the chocolate industry and specifically means for preparing chocolate based on personal preference.

### BACKGROUND ART

References considered to be relevant as background to the presently disclosed subject matter are listed below:
International patent application publication No. WO2011007379
US patent application publication No. US20120237665
US patent application publication No. US20150024109
US patent application publication No. US20160037795
US patent application publication No. US20110052771
US patent application publication No. US20080274241
US patent application publication No. US20080274241
US patent application publication No. US20160205963
Samira Kazan “HOW TO MAKE WHITE CHOCOLATE” Jun. 19, 2020 How To Make White Chocolate—Alphafoodie, https://www.alphafoodie.com/how-to-make-white-chocolate/
Glee Gum's-Make Your Own Chocolate Kit by KRISTIN, 24 Aug. 2014, retrieved from https://itsfreeatlast.com/glee-gums-make-chocolate-kit
Stephen T Beckett “The Science of Chocolate” 2^{nd} Edition, RSC Publishing, 2009, page 26;
R. Lees & E. B. Jackson “Sugar Confectionery and Chocolate Manufacture” Blackie Academic & Professionals, 1973, Page 19.

Acknowledgement of the above references herein is not to be inferred as meaning that these are in any way relevant to the patentability of the presently disclosed subject matter.

### BACKGROUND

Traditional chocolate making methods involves roasting, cracking and winnowing fermented and dried cocoa beans to cocoa nibs, which are ground into cocoa mass. Then, sugar and other flavoring agents such as milk powder can be added and farther refined together with the cocoa mass. At this stage, the liquid chocolate is conched by heating the chocolate while agitating it, for taste and texture development and subsequently tempered to produce the desired crystalline structure of the cocoa butter in the V form. The tempered chocolate can be stored or molded.

WO2011007379A1 describes a manufacturing method where the sugar is refined prior to the mixing with other ingredients, each being separately added.

US20120237665A1, US20150024109A1, and US20160037795A1 describe different methods to produce heat resistant chocolate confection.

US20110052771A1 describes a process for the manufacturing of low-fat chocolate-like confection.

The product of all these manufacturing methods is a chocolate bar or a chocolate confection, packaged and shipped to a retailer.

US20080274241 describes a method and apparatus for making custom chocolate articles at an onsite location comprises a temperature-controlled chocolate tempering machine. The customers can choose their ingredients e.g., type of chocolate, toppings etc., The selected ingredients are melted and tempered in a temperature-controlled chocolate tempering machine comprising an agitator. After this process, the liquefied chocolate is poured into the molds and the final customized chocolate is delivered to the customer.

US20160205963 describes a method and apparatus for making small batches of chocolate. The apparatus refines, conches and tempers chocolate at the same chamber, and extracts the tempered chocolate to a connected mold. The ingredients are divided to chocolate precursors: cocoa nibs or cocoa mass and cocoa butter, and additives: sugar, milk powder, spices etc. This apparatus could be suitable for home users that want to custom-select the ingredients of their chocolate bars.

Homemade white chocolate was described by Alphafoodie.com where sugar powder and milk powder are added to the cacao butter molten and then the three ingredients are processed in a food processor.

Further, using sucrose powder in chocolate making is described by Beckett S. in the book of Science of Chocolate. Inter alia, the book deals with the difficulty in producing fine sugar, risk of explosions and the risk in formation of damp sugar.

Finally, the risks of explosion while producing sugar dust is also described by Lees & Jackson.

### GENERAL DESCRIPTION

The present disclosure provides, in accordance with a first of its aspects, a chocolate making base unit comprising, refined together, cocoa butter or cocoa butter alternative and a chocolate making ingredient in particulate form; wherein the chocolate making base unit is free of cocoa solids and milk (dairy components).

The present disclosure provides, in accordance with a second aspect, a method of preparing a chocolate making base unit, the method comprising:
refining a mixture of cocoa butter and at least one chocolate making ingredient in particulate form and optionally an emulsifier to obtain a homogenous molten of the cocoa butter or alternative thereof and said at least one chocolate making ingredient;
wherein said mixture is lacking cocoa solids and milk.

In some preferred examples, the chocolate making ingredient comprises, consists essentially of, or consists of a sweetener in particulate form and optionally an emulsifier.

In some more preferred examples, the chocolate making ingredient consists essentially or consists of a sweetener.

In accordance with a third aspect, the present disclosure provides a method of preparing personalized chocolate, the method comprises:
(a) providing two or more chocolate making units, at least one being a chocolate making base unit disclosed herein, and at least one supplementary unit or a user's choice;
(b) melting a mixture of said base unit and said supplementary unit to form a chocolate molten; and,
(c) cooling said molten to form said personalized chocolate.

The present disclosure provides, in accordance with a fourth of its aspects, a chocolate making package for use in preparing a personalized chocolate product, the package comprising a chocolate making base unit disclosed herein and instructions for use of same to form a personalized chocolate product, said instructions comprising at least mixing and heating the base unit with at least one chocolate making supplementary unit to form a homogenous molten and allowing the molten to cool.

In accordance with yet a fifth aspect, the present disclosure provides a chocolate making package for use in preparing a personalized chocolate product, the package comprising at least one, at times, two or more chocolate making unit, at least one of the chocolate making units being a chocolate making base unit as disclosed herein, and optionally at least one other chocolate making unit that is a supplementary unit that comprises at least one chocolate making ingredient that is different from the base unit; and instructions for use of same to form a personalized chocolate product.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1B provide a flow chart showing the process of preparing a chocolate making base unit (FIG. 1A) and a chocolate making supplementary unit (FIG. 1B).

FIG. 2 provides a schematic flow chart of a process of preparing a personalized chocolate product.

FIG. 3 provides a schematic flow chart of different combinations of a base unit and supplementary units to form different types of chocolate products. DETAILED

### DESCRIPTION

Typical chocolate making involves blending cocoa mass (the product from ground cocoa nibs, also known as unsweetened chocolate or cocoa liquor) with cocoa butter and sugar. After the mixing, the blend is further refined to bring the particle size of any added ingredient, such as added milk and sugar down to a desired fineness. Cocoa mass, cocoa butter and cocoa powder are blended with sugar and other ingredients in varying quantities to make different types of chocolate bars. For example, milk chocolate is typically a blend of sugar, milk powder, cocoa liquor, cocoa butter, lecithin and optionally Vanilla; white chocolate is typically a blend of sugar, milk powder, cocoa butter, lecithin and Vanilla and plain dark chocolate is typically a blend of cocoa liquor, cocoa butter, sugar and lecithin.

Consumers have almost no control over the composition of chocolate bars they consume and have no way to relatively easy obtain high quality chocolate, with a personal choice of ingredients and flavors. While attempts have been described to prepare home-made chocolate, this is challenging due to the risks and difficulties involved in producing and using sugar dust, lack of suitable ingredients that can be homogenously combined into a personalized, high quality and smooth, chocolate bar.

The technology disclosed herein is based on the understanding that in order to prepare a personalized chocolate bar, one should have a ready to use base ingredient (referred to herein as a “base unit”) that comprises or essentially consist of a homogenous blend of edible fat (preferably cocoa butter and/or alternatives thereof, as further discussed below) and the fine powdered sweetener, intimately mixed together into what is referred to herein as a refined or conched mixture; and use this base unit for subsequent combinations, by the end user, with other ingredients, according to one's own personal preference.

The above is based on the realization that the processing of the fat with the particulate matter, specifically, a sweetener in particulate form, in a manner that reduces the particles size of the sweetener while allowing the fat to intimately mix and coat the particulate sweetener is a limiting factor in providing a universal unit for personal chocolate making. Further, it has been realized that it is sufficient to intimately mix these two ingredients (with the optional addition of emulsifiers) to provide a universal base unit for the later production of chocolate of any desired taste or type.

Importantly, the herein disclosed base unit does not include cocoa solids. By using a base unit, as disclosed herein, any supplemental ingredient of a personal preference can be added to the a priori base unit, and result in a high quality, personalized, chocolate confection.

Thus, the present disclosure provides, in the context of a first of its aspects, a chocolate making base unit for the preparation of personalized chocolate, the chocolate base unit comprising, intimately mixed together (i.e. refined or conched), edible fat including cocoa butter and/or cocoa butter acceptable alternatives and at least one additional ingredient being at least a sweetener, the latter in particulate form, the base unit being free of cocoa solids and milk or animal derived milk components. The lack of cocoa solids and milk in the refined base unit is essential to ensure the possibility of using the universal base unit in the production of any type of chocolate. In other words, the lack of cocoa solids allows for the use of the base unit in preparing a personalized milk chocolate; while the lack of milk components (e.g. milk powder) allows for the personalized production of dark chocolate.

In some examples, the base unit may comprise emulsifier(s).

In some examples, the base unit consists essentially of cocoa butter and a sweetener in particulate form, and optionally an emulsifier.

In some examples, the base unit is essentially free of water.

In the context of the present disclosure, when referring to “edible fat” it is to be understood to encompass an edible lipid or combination of lipids that are solid at room temperature and can be used as alternatives for cocoa butter (cocoa butter compatible fat). In some examples, the fat is animal free.

In the context of the present disclosure, when referring to cocoa butter it is to be understood as referring to fat extracted from the cocoa beans from the fruit of Theobroma cacao (cacao tree), as well as to cocoa butter compatible fats and to mixtures of cocoa butter and cocoa butter fat compatibles. The cocoa butter (i.e. chocolate fat component) is typically extracted from cocoa mass, cocoa beans that have been ground to release the fat from the vegetable cells.

In the context of the present disclosure, the cocoa butter or the cocoa butter alternative is devoid of detectable cacao solids (the mixture of non-fat substances, typically provided in a form of a powder, thus referred to by the term cocoa powder).

The cocoa butter alternative or cocoa butter compatible fat can be any fat that fall under the definition of cocoa butter alternative, including cocoa butter equivalents (CBE) or cocoa butter replacers (CBR). In other words, the cocoa butter compatible fat is one that shares similar melt profiles.

In some examples, the cocoa butter compatible fat is any vegetable fat allowed by the relevant authorities, such as the EU Directive, in chocolate.

In some examples, the cocoa butter compatible fat shall comply with the following criteria:
(a) they are non-lauric vegetable fats, which are rich in symmetrical monounsaturated triglycerides of the type POP, POSt and StOSt;
(b) they are miscible in any proportion with cocoa butter, and are compatible with its physical properties (melting point and crystallization temperature, melting rate);
(c) they are obtained only by the processes of refining and/or fractionation, which excludes enzymatic modification of the triglyceride structure.

A non-limiting list of animal free fat that can be used as a cocoa butter alternative or cocoa butter compatible, includes illipe oil (shorea spp.), palm oil (Elaeis guineensis, Elaeis olifera), Sal oil (Shorea robusta), Shea oil (Butyrospermum parkii), Kokum gurgi (Garcinia indica), Mango kernel (Mangifera indica), and combinations of same. The base unit can comprise a cocoa butter alternative with or without cocoa butter.

In some examples, the base unit consists essentially of cocoa butter as the fat component and sugar as a sweetener.

The sweetener in the chocolate making base unit is in particulate form.

In the context of the present disclosure, the sweetener can be any type of sweetener in particulate form, including naturally occurring sweeteners, synthetic sweeteners as well as semi-synthetic sweeteners, high intense sweeteners, naturally derived sugar alternatives etc.

In some examples, the sweetener is a water soluble/hydrophilic sweetener, thus requiring its intimate mixing with the fat to allow its even dispersion within the fat.

In some examples, the sweetener is a dry sweetener, i.e. essentially free of water. This improves the viscosity and temper of the resulting melt.

In some examples, the sweetener comprises or is sugar (sucrose) such as table (granulated) sugar, caster sugar, confectioners sugar, pearl sugar, sanding sugar, cane sugar, Demerara sugar, turbinado sugar, muscovado sugar, light brown sugar, dark brown sugar. The sugar may be organic or non-organic.

In some other examples, the sweetener comprises a sucrose substitute.

In some other examples, the sweetener comprises polyols, for example, erythritol, isomalt, lactitol, maltitol, mannitol, sorbitol and xylitol.

In some examples, the sweetener comprises artificial alternative sweeteners, such as Sucralose (produced by the substitution of three of the hydroxyl groups in sucrose with chlorine), maltodextrin. Yet, in a preferred example, the sweetener is all natural, thus making the personalized chocolate free of artificial ingredients.

In some examples, the sweetener is of natural source, e.g. from plant or plant part. Sweeteners from natural source fall within the scope of naturally derived sweetener.

In some examples, the sweetener comprises oligofructose and for example, inulin.

In some examples, the sweetener comprises stevia, e.g. extracted from leaves of the plant species Stevia Rebaudiana, including any one or combination of the glycosides present in the plant, including one or combination of stevioside (known to be 250-300 more sweet than sugar), rebaudioside A (350-450× of sugar), rebaudioside C, dulcoside A, Rebaudioside B, Rebaudioside D, Rebaudioside E, steviobioside, and stevioglycoside.

In some examples, the sweetener comprises or is mogrosides, e.g. sweetener derived from monk fruit.

In some examples, the sweetener comprises or is D-Psicose, e.g. allulose.

The sweetener is solid or semi solid at room temperature (e.g. 25° C.). In some preferred examples, the sweetener constitutes the particulate matter of the base unit.

In some examples, the base unit is defined by the weight ratio between the edible fat, i.e. cocoa butter and the sweetener.

In some examples, this includes fat to sweetener (in particulate form) ratio from 85% to 15% and 15% to 85%. The ratio can depend, inter alia, on the type of fat and type of sweetener, and the type of personalized chocolate to be prepared.

In some examples, the weight ratio between the fat, preferably cocoa butter, and the sweetener is about 40% and 60%, at times between 30% to 70%. Yet, it should be appreciated that when using high intensity sweeteners, for example Stevia, the amount of sweetener can be lower.

In some examples, the base unit is defined by the weight percent (% wt) of the fat, preferably cocoa butter, in the base unit. In some examples, the % wt of the fat in the base unit is between 15% and 85%, at times, between 15% and 50%, at times, between 20% and 50%, at times, between 30% and 70%, at times between 10% and 40%.

In some examples, the base unit is defined by the weight percent (% wt) of the sweetener in the base unit. In some examples, the % wt of the sweetener in the base unit is between 15% and 85%, at times, between 15% and 50%, at times, between 20% and 50%, at times, between 30% and 70%, at times between 10% and 40%; at times, less than 10% sweetener, at times, between 1% and 9%.

The amount of fat and sweetener together typically constitute above 80 wt % out of the total weight of the base unit, at times above about 90 wt %, or even above 95 wt %.

In some examples, the base unit consists of cocoa butter, a sweetener, and optionally an emulsifier.

In some examples, the sweetener is sugar and the % wt of the cocoa butter after homogenously and intimately mixing (refining/conching) with the sugar is between 30% and 50%, the intimate mixing is optionally in combination with an emulsifier.

In some examples, the sweetener is a formulation of erythritol with stevia extract or erythritol with monk fruit extract, and the % wt of the cocoa butter after homogenously mixing (refining/conching) with the sweetener formulation is between 30% and 50%. In some examples, inulin and/or allulose could be used in addition or instead of erythritol.

The chocolate making base unit is prepared by intimate mixing of the fat with at least the sweetener. When referring to intimate mixing it is to be understood to encompass mechanical mixing under conditions that cause a priori a homogenous blend and size reduction (e.g. grinding) of the particulate matter within the blend. In some examples, the intimate mixing also comprises or involves heating of the fat, e.g. cocoa butter resulting in its liquidation. The heating can be an inherent result of the vigorous mixing of the fat e.g. (cocoa butter) and the particulate matter including at least the sweetener.

In some examples, the particulate matter (including at least the sweetener but optionally also other ingredients such as the emulsifiers, prebiotic fibers etc) in the chocolate making base unit (after the refinement with the fat) typically has an average size or has a size distribution of d90 of less than 50 μm, at times, less than 40 μm, at times less than 35 μm, at times less than 34 μm, at times less than 33 μm, at times less than 32 μm, at times less than 31 μm, at times less than 30 μm, at times less than 29 μm, at times less than 28 μm, at times less than 27 μm, at times less than 26 μm, at times less than 25 μm, at times less than 24 μm, at times less than 23 μm, at times less than 22 μm, at times less than 21 μm, at times less than 20 μm, at times less than 19 μm, at times less than 18 μm, at times less than 17 μm, at times less than 16 μm, at times less than 15 μm, at times less than 14 μm, at times less than 13 μm, at times less than 12 μm, at times less than 11 μm, at times less than 10 μm, at times less than 9 μm, at times less than 8 μm, at times less than 7 μm, at times less than 6 μm, at times less than 5 μm, at times less than 4 μm, at times less than 3 μm, at times less than 2 μm.

In some other examples, the particulate matter within the base unit (after the refinement with the fat) has an average size or a size distribution of d90 that is greater than 1 μm, at times greater than 2 μm, at times greater than 3 μm, at times greater than 4 μm, at times greater than 5 μm, at times greater than 6 μm, at times greater than 7 μm, at times greater than 8 μm, at times greater than 9 μm, at times greater than 10 μm, at times greater than 11 μm, at times greater than 12 μm, at times greater than 13 μm, at times greater than 14 μm, at times greater than 15 μm, at times greater than 16 μm, at times greater than 17 μm, at times greater than 18 μm, at times greater than 19 μm, at times greater than 20 μm, at times greater than 21 μm, at times greater than 22 μm, at times greater than 23 μm, at times greater than 24 μm, at times greater than 25 μm, at times greater than 26 μm, at times greater than 27 μm, at times greater than 28 μm, at times greater than 29 μm, at times greater than 30 μm, at times greater than 35 μm, at times greater than 40 μm.

In some examples, the particulate matter within the base unit, after refinement, has an average size or has a size distribution of d90 within the range of 1 μm and 40 μm, at times, between 10 μm and 30 μm, at times between 10 μm and 25 μm, at times between 5 μm and 20μ, at times between 5 μm and 25 μm.

In some examples, the chocolate making base unit comprises particulate matter having a size distribution of d90 of 40 μm, at times, of 30 μm, at times, of 25 μm, and preferably at times of 20 μm.

It is known that crystalline sweeteners, such as sugar, and to greater extent refined sweetener/sugar (featuring larger surface area), absorb moisture. As humidity increases the moisture content increases dramatically thereby resulting in a damp sugar that will inherently suffer from undesired microbiol contamination and from sticking together and forming lumps (“The Science of Chocolate”, page 26), thus reducing the quality of the sugar. Therefore, the refinement of sugar without fat would result in a hygroscopic dust which requires its immediate combination with the cocoa butter to avoid absorbance of water. In other words, it is essential that the refinement of the sweetener be together with the fat component, which is believed to coat the powder and thus ‘protect’ it from the surrounding environment.

In addition, the coating of the refined sugar with the fat provides the pleasant flow characteristic in the mouth, lower viscosity and easier processing of the ingredients.

Further, care must be taken when milling sweeteners, such as sugar, especially by itself, because of the high risk of sugar dusk explosion, a risk that increases in reverse proportion to particle size (“Sugar Confectionery and Chocolate Manufacture”, page 19 second paragraph).

Therefore, the process of refining the sugar to the relevant particle size is not practical nor it is safe for home users.

As noted above, the chocolate making base unit also comprises one or more additional ingredients.

While the chocolate making base unit can comprises other ingredients (other than the sweetener in particulate form), the base unit does not comprise, as noted above, cocoa solids, or cocoa powder and/or cocoa mass (cocoa liquor) and milk (including milk components).

In some examples, the chocolate making base unit comprises alternative milk components, i.e. that are not dairy or animal derived that can be used as milk replacements. In this connection, it is important to note that such base unit is not considered and should be excluded from any meaning of containing milk.

In some examples, the chocolate making base unit is essentially free of water or at least essentially free of a detectable amount of water, or at least free of an amount of water that may diminish the quality of the resulting personalized chocolate.

In some examples, the term “essentially free” denotes an amount of water of less than 2% v/v, at times even less than 1% v/v out of the total volume of the base unit.

The chocolate making base unit is used for the preparation of personalized chocolate product.

A personalized chocolate product, in the context of the present disclosure, should be understood as referring to any chocolate product in which the composition and thus, the taste, mouthfeel, and organoleptic characteristics are dictated by the person's choice of supplementary units, when preparing or requesting the production of the chocolate product.

In some examples, the personalized chocolate product can be prepared in any form that is solid at 25° C. The personalized chocolate product can be the final product, e.g. ready for consumption or can be produced as an interim ingredient for subsequent inclusion into a final food product, e.g. baked products, confectionary products, beverages etc.

For the preparation of the personalized chocolate, the base unit is mixed with at least one additional chocolate making unit (referred to herein as a “chocolate making supplementary unit” or in brief “supplementary unit”) that comprises one or more chocolate making ingredients. The supplementary unit does not have to be product of refinement, as the base unit, although in some examples, it is also refined prior to its mixing with the base unit (e.g. when the additional ingredient is a powder such as milk powder being refined with fat prior to mixing with the base unit).

In some examples, the personalized chocolate requires the mixing together of two or more chocolate making units, at least one of which is a chocolate making base unit. Surprisingly, since the chocolate making base unit is already in refined form (where the butter and sweetener are refined and/or conched together) there is no need for subsequent refining steps and even simple mixing of the base unit with a supplementary unit would result in high quality, personalized chocolate. This being said, the present disclosure also includes refinement of the base unit(s) with the supplementary unit(s).

In the context of the present disclosure the chocolate making supplementary unit is different from the chocolate making base unit (“base unit”) by at least one ingredient, either added or eliminated as compared to the base unit. Thus, in the context of the present disclosure, it is possible that the base unit and the supplementary unit comprise fat and sweetener (i.e. same type of ingredients), yet at different ratios and/or of different types of fat and/or sweetener.

In the above and below disclosure, the chocolate making base unit and the chocolate making supplementary unit are collectively referred to by the term “chocolate making unit”. In other words, the term “chocolate making unit” is to be understood as referring to either the base unit or the supplementary unit. The specific meaning should be interpreted in line with the context that it is recited.

In some examples, the supplementary unit can include fat, e.g. cocoa butter and other ingredients, yet without a sweetener.

In some other examples, the supplementary unit can include a sweetener but would lack the cocoa butter.

In some other examples, the supplementary unit is one lacking both the cocoa butter and the sweetener, e.g. comprising vanilla flavor with cocoa butter compatible fat.

Thus, in some examples, the supplementary unit comprises cocoa butter but is lacking the sweetener of the base unit.

In some other examples, the supplementary unit comprises cocoa butter and the sweetener of the base unit, but at different amounts/ratio as in the base unit.

In some examples, the supplementary unit is lacking cocoa butter, e.g. including instead cocoa butter compatible fat.

In some examples, the supplementary unit comprises fat, e.g. cocoa butter in an amount that is different from the base unit.

In some examples, the supplementary unit comprises fat, e.g. cocoa butter in combination with an ingredient that is other than a sweetener.

Other chocolate making ingredients that can be included in the supplementary unit include, without being limited thereto, milk powder, cocoa mass, cocoa butter alternative, nut butter, flavoring agents, functional food ingredient, biotics, lipophilic ingredients, emulsifiers.

In some examples, the supplementary unit comprises milk powder, in some examples, mixed with fat, e.g. cocoa butter.

In the context of this example, the milk powder can contain whole milk powder, skim milk powder, whey milk powder, milk protein concentrate, lactose, modified milk, vegan (non-dairy/animal free) milk alternatives in powder form such as those recognized as soya milk, pea milk, peanut milk, flax milk, oat milk, rice milk, almond milk, walnut milk, coconut milk, hemp milk, cashew milk, tapioca milk, buckwheat milk and even recombinant milk, lactose-free milk and flora-made dairy protein.

In one non-limiting example, the supplementary unit is a milk unit comprising milk powder and cocoa butter in the amounts of 21 grams of milk powder in 9 grams of cocoa butter to produce a 70% milk unit of total 30 grams.

In some other examples, the supplementary unit comprises nut butter.

In some other examples, the supplementary unit comprises one or a combination of flavoring agents/spices, such as any one or combination of vanilla, salt, pepper, caramel, mint or other herbs, strawberry or other fruit flavor. In such cases, the supplementary unit does not necessarily contain cocoa butter.

In one non-limiting example, the flavor is a vanilla flavor.

In some examples, the supplementary unit comprises cocoa mass (cocoa liquor) refined from cocoa beans, i.e. a natural combination of cocoa butter and cocoa solids and no added sugar. In one non-limiting example, the cocoa mass unit comprises about 54% cocoa butter and about 46% cocoa solids. It is to be appreciated that the amount of fat in the cocoa mass can vary depending on the cocoa beans and especially depending on where they were grown and its proximity to the equator. When referring to cocoa mass, the amounts indicated above are exemplary only.

In some examples, the supplementary unit comprises a functional food ingredient, i.e. ingredients that are known to provide a beneficiary effect on the well-being of the subject consuming the food, in this case, the personalized chocolate. This may include, without being limited thereto essential oils, cannabinoids, biotics.

In some examples, the supplementary unit comprises biotics, e.g. prebiotics and/or probiotics.

For examples, the biotics can comprise probiotics, added as drops into liquid cocoa butter or to a chocolate mixture at temperatures that do not damage the biotics, e.g. below 40° C. Such drops can contain, for examples, 20 million Reuteri bacteria.

In some other examples, the biotics can comprise prebiotics grinded and possibility conched with cocoa butter. An example of prebiotics is inulin.

In some examples, the supplementary unit can comprise oil based/lipophilic ingredients, such as nut butters: hazelnut butter, cashew butter, almond butter, coconut butter, essential oils such as citrus oil, lavender oil, peppermint oil and so on.

The chocolate making unit, be it the base unit and/or the supplementary unit, can also comprise one or more emulsifiers.

In some examples, the emulsifier comprises lecithin. In the context of the present disclosure, the lecithin can be animal derived as well as vegetable lecithin. In preferred cases, the lecithin is a vegetable derived lecithin, such as lecithin extracted from soybeans or the artificial lecithin identified in the art by the E number E322.

This base unit can be part of a package comprising at least the base unit and instructions for use of the base unit for the preparation of chocolate products according to the user's own preference of ingredients.

Thus, in the context of the present disclosure, also provided herein is a package for the preparation of personalized chocolate product, e.g. chocolate bars or chocolate confections, the package comprising at least one chocolate making base unit and instructions for use of same for the preparation of a personalized chocolate product.

The package disclosed herein can also comprise at least one chocolate making unit that is a supplemental to the base unit (thus referred to herein as the “supplementary unit”).

Thus, in some examples, the package comprises two or more chocolate making units, at least one of the chocolate-making units is a chocolate making base unit and at least one other chocolate making unit is a chocolate making supplementary unit, wherein the base unit comprises a blend of fat e.g. cocoa butter and/or cocoa butter compatible, as defined herein, and a sweetener that is in particulate form, intimately mixed/conched together, as defined above.

In some examples, the chocolate making package comprises two or more, typically a plurality of chocolate making base units.

In some examples, the package comprises at least one chocolate making base unit and at least one chocolate making supplementary unit.

In some examples, the package comprises a plurality of chocolate making base units and a plurality of supplementary units.

In some examples, the package comprises a plurality of chocolate making base units and a plurality of the same type of chocolate making supplementary units, e.g. all providing ingredients for forming milk chocolate or all providing ingredients for forming dark chocolate.

In some examples, the package comprises a plurality of chocolate making base units and a plurality of two or more types of chocolate making supplementary units.

In some examples, the content of the package can be personalized. For instance, a consumer orders a package in which the composition of the supplementary units is a priori selected according to his own preference, e.g. by defining the types of personalized chocolate he or she desires to produce. To this end, the package may be provided with instructions on how to blend the units in order to obtain the desired chocolate products.

The chocolate making base unit is mixed with other ingredients, such as the supplemental ingredients to form the personalized chocolate product.

In the context of the present disclosure, when referring to the chocolate making units and the manner by which the ingredients are mixed together to form the personalized chocolate product, it is to be understood as referring to a homogenous melt which result in the fat, e.g. cocoa butter at least from the base unit liquidizes to form a homogenous blend of all ingredients. Such mixing of the base unit with the supplementary unit does not require (although it may include) refinement.

In some examples, the mixing of the base unit with the additional ingredients within the supplementary unit(s) comprises also aeration of the blend, e.g. for the formation of personalized mousse.

The mixing of the base unit with the additional ingredients within the supplementary unit(s) comprises heating of the mixed components to cause liquidation of the base unit.

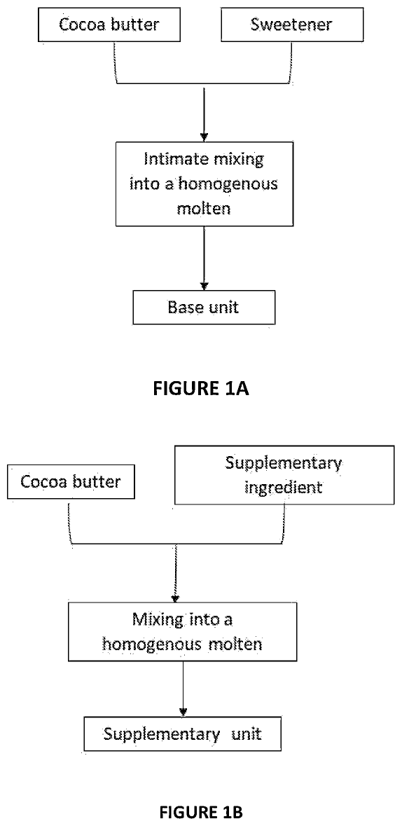

Reference is now made to FIGS. 1A-1B providing flow charts for the preparation of the chocolate making base unit (FIG. 1A) and the chocolate making supplementary unit (FIG. 1B), in accordance with some non-limiting examples.

Specifically, FIG. 1A shows that fat, in this example, cocoa butter is combined with a sweetener in a process that involves intimate mixing of the two ingredients into a homogenous dispersion of the particulate matter within the butter molten. The intimate mixing avoids the formation of agglomerates, water absorption, and the refined particulate matter dispersed inside the molten are coated with cocoa butter molten. This lack of agglomerates can be viewed using a dedicated microscope (e.g. where size of the particles is assessed and shown to be below about 50 μm).

The intimate mixing that involves size reduction/refining of the sweetener and the formation of an intimate blend of the base unit can be carried out in any size reduction machine known in the food industry. Without being limited thereto, the intimate mixing and size reduction can be achieved in an industrial ball mill and/or roll mill and/or stone grinder under the conditions known in the art of chocolate manufacturing (e.g. https://www.buyindiankitchen.com/catalogsearch/result/?q=chocolate).

In FIG. 1B, there is provided a flow chart of the preparation of the supplementary unit which, in this non-limiting example, comprises a combination of cocoa butter and a supplementary ingredient. As shown, for the preparation of the supplementary unit, there is no mandatory requirement for intimate mixing of the ingredients (although it can be used), and simple mixing, optionally with heating of the butter, can also be applied. This is typically the case when flavoring agents are mixed with molten fat/cocoa butter. Yet, in case the ingredients in the supplementary unit are in powder form, such as milk powder, the intimate mixing/refinement is preferable.

The chocolate making units are then used for the preparation of personalized chocolate products.

In some examples, the method of preparing a personalized chocolate product comprises providing two or more chocolate making units, at least one being a base unit as described herein, and at least one other unit being a personally selected supplementary unit.

In some examples, the method of making the personalized chocolate comprises mixing with heating the base unit and the supplementary unit(s) to form a homogenous molten.

In some examples, the method of making the personalized chocolate comprising tempering the homogenous blend of the units.

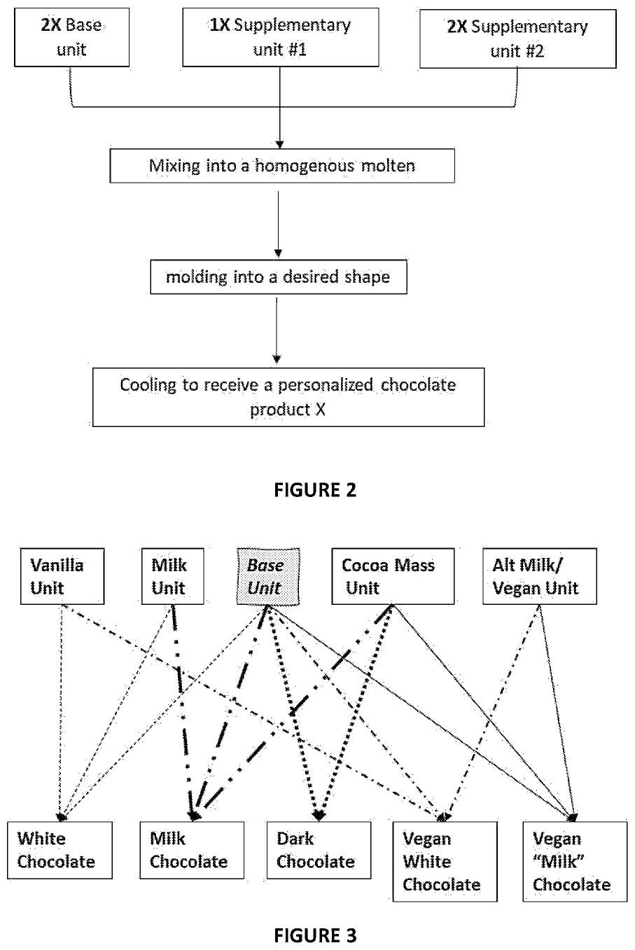

The personalized chocolate can be prepared by any combination of at least one base unit and one or a plurality of supplementary units. For illustration, FIG. 2 provides a schematic flow chart for preparing a personalized chocolate product “X” that involves the combining of two units of a base unit with two different supplementary units including one unit of supplementary unit #1 and two units of supplementary unit #2. It is noted that the mixing of the units together does not require the high sheer forces (i.e. refinement) that is required for the preparation of the base unit.

Once formed, the chocolate making units (the base unit or the supplementary unit) can be molded into desired shapes, cooled and packed into units of pre-defined amounts so that one can easily combine units according to its own preference or according to a given recipe.

In some cases, the chocolate making units are subjected to tempering step before molding.

For further illustration, FIG. 3 provides a schematic flow chart for the preparation of different types of chocolate products:
[symbol] combining together at least one base unit, at least one milk unit comprising milk powder and cocoa butter conched together, and at least one vanilla flavor unit;
[symbol] combining together at least one base unit, at least one milk unit comprising milk powder and cocoa butter conched together, and at least one cocoa mass unit;
[symbol] combining together at least one base unit with at least one cocoa mass unit;
[symbol] combining together at least one base unit with at least one chocolate making unit where the chocolate ingredient is alternative milk powder.

For further illustration, Table 1 provides amounts to be combined of a base unit, the milk unit, the vanilla flavor unit and the cocoa mass unit, each being of a type described above as some non-limiting examples and having a total weight of 40 gr.

TABLE 1
Chocolate Making Combinations

| | Base | Milk | Alternative | Vanilla | Cocoa mass |
|---|---|---|---|---|---|
| Chocolate type | unit | unit | Milk Unit | unit | unit |
| Dark 88% cacao | 1 | 0 | 0 | 0 | 4 |
| Dark, 76% cacao | 2 | 0 | 0 | 0 | 3 |
| Dark, 64% cacao | 3 | 0 | 0 | 0 | 2 |
| Dark milk, 64% | 2 | 1 | 0 | 0 | 2 |
| cacao | | | | | |
| Milk, 44% cacao | 2 | 2 | 0 | 0 | 1 |
| Vegan “milk”, 44% | 2 | 0 | 2 | 0 | 1 |
| cacao | | | | | |
| White, 40% cacao | 2 | 3 | 0 | 1 | 0 |
| Vegan White, 40% | 2 | 0 | 3 | 1 | 0 |
| cacao | | | | | |

For example, if one base unit has a total weight of 40 grams and is composed of 24 grams of cane sugar and 16 grams of cocoa butter conched together, and the cocoa mass unit comprises 40 grams of cocoa mass, by mixing and melting and optionally tempering together 2 base units with 3 cocoa mass units a 200 gr product of a 76% dark chocolate is obtained.

As used herein, the forms [symbol] and [symbol] include singular as well as plural references unless the context clearly dictates otherwise. For example, the term [symbol] includes one or more types of sweeteners, similarly, the term [symbol] includes one or more types of fats.

Further, as used herein, the term [symbol] is intended to mean that the composition include the recited ingredients, i.e. the fat and the sweetener, but not excluding other ingredients, such as flavoring agents, emulsifiers, as long as they are not literally excluded from the list of possible ingredients (e.g. such as in the case of cocoa solids or milk in the base unit). The term [symbol] is used to define units which include the recited ingredients but exclude other ingredients that may have a significance on the formation of the chocolate product. [symbol] Consisting of shall thus mean excluding more than trace amounts of ingredients other than those specifically recited. Embodiments defined by each of these transition terms are within the scope of this disclosure.

Further, all numerical values, e.g. when referring the amounts or ranges of the ingredients constituting the units or product disclosed herein, are approximations which are varied (+) or (−) by up to 20%, at times by up to 10% from the stated values. It is to be understood, even if not always explicitly stated that all numerical designations are preceded by the term [symbol] .

The invention will now be exemplified in the following description of experiments that were carried out in accordance with the present disclosure. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DETAILED DESCRIPTION OF NON-LIMITING EXAMPLES

### Example 1—Preparing Chocolate Making Units

The different chocolate making units were conched together using a Spectra mini stone grinder. Specifically, cocoa butter chips (product of CacaoTV, Olam Cocoa Deutschland GmbH) were melted and added to the stone grinder maintained at a temperature of between 40° C. and 70° C., after which the chocolate making ingredient was added so as to mix and conch the cocoa butter molten and chocolate ingredient together and provide a conched blend of the cocoa butter and chocolate making ingredient in particulate form. The conching in the grinder was for 12-24 hours when the particles size was determined to be below 25 μm using a grindometer (0-50 μm Baoshishan grindometer). The duration of conching in the grinder may vary depending on the desired particle size of the resulting blend to be less than 30 μm.

After conching, the homogenous blend was poured into molds, cooled and eventually extracted from the mold and packed as individual chocolate making units.

According to the above procedure chocolate making base units as well as different types of chocolate making supplementary units were prepared. Table 2 provides amounts of cocoa butter, and types and amounts of the additional ingredients mixed together to form the base unit or the different types of supplementary units. The base unit weight 40 gr while each supplementary unit weight 30 gr.

TABLE 2
Chocolate making units

| | Cocoa butter | | Ingredient | Ingredient | | Cocoa butter |
|---|---|---|---|---|---|---|
| Type | [gr] | | type | [gr] | | [% wt] |
| Base unit | 16 | gr | Organic cane | 24 | gr | 40% |
| | | | sugar | | | |
| Cocoa mass | — | | Cocoa mass | 30 | gr | 0% |
| unit | | | | | | |
| Milk unit | 9 | gr | Whole milk | 21 | gr | 30% |
| | | | powder | | | |
| Coconut unit | 9 | gr | Coconut cream | 21 | gr | 30% |
| | | | powder | | | |
| Vanilla unit | 0.05 | gr | Vanilla powder | 0.95 | gr | 95% |

In a slightly modified procedure, before molding, the molten mixture was tempered in a Chocovision Rev2B tempering machine. The tempered chocolate blend was then allowed to solidify at 6° C. and once solidified, extracted from the mold, and packed, as described hereinbefore.

### Example 2—Preparation of Personalized Chocolate

For the preparation of a chocolate based on a personal preference, different supplementary units were mixed with amounts of base units. Without being limited thereto, the following examples, were prepared by mixing the units as indicated in each Example.

### Example 2A—Milk Chocolate

Milk chocolate was prepared by melting and mixing the base unit and chocolate making supplementary ingredients at the amounts detailed in Table 3A.

TABLE 3A
Milk chocolate

| Unit | Unit amount |
|---|---|
| Base unit | 2 |
| Cocoa mass unit | 1 |
| Milk unit | 2 |

The chocolate making units were melted and mixed. Then the chocolate mixture was tempered, poured into molds and cooled at 6° C. The final milk chocolate bars weighted 170 grams and contained 47% cacao.

### Example 2B—Vegan Chocolate

Vegan “milk” chocolate was prepared by mixing the base unit and chocolate making supplementary ingredients at the amounts detailed in Table 3B.

TABLE 3B
Vegan chocolate

| Unit | Unit amount |
|---|---|
| Base unit | 2 |
| Cocoa mass unit | 1 |
| Coconut unit | 1 |

The chocolate making units were melted and mixed. Then the chocolate mixture was tempered, poured into molds and left to cool at 6° C. The final vegan coconut chocolate bars weighted 140 grams and contained 51% cacao.

### Example 2C—White Chocolate

White chocolate was prepared by mixing the base unit and chocolate making supplementary ingredients at the amounts detailed in Table 3C.

TABLE 3C
White chocolate

| Unit | Unit amount |
|---|---|
| Base unit | 2 |
| Milk unit | 3 |

The chocolate making units were melted and mixed. To the mixture, 0.5 tea spoon of vanilla paste or 1 drop of vanilla supplementary unit (about 1 gram) was added. Then the chocolate mixture was tempered, poured into molds and left to cool at 6° C. The final white chocolate bars weighted 170 grams and contained 35% cacao.

### Example 2D: Chocolate with Probiotics

Chocolate with probiotics was prepared by adding 10 drops of BioGaia probiotics, containing at least 200 million L. reuteri bacteria, into the molten of the white chocolate described in table 3D. The probiotics drops where added and mixed into the molten chocolate while the molten was cooled below 40° C.

### Example 3—Comparative Example

In order to exhibit the significance of preparing a base unit and mixing the base unit with supplementary units, a comparison was made where cocoa butter was used without a priori conching with sugar (sweetener) and refined sugar was used as a separate ingredient. To this end, sugar (product of Ashbal Functional Foods) was refined using a blender until an extra fine sugar with particle size of about 35 microns was obtained. To measure the particle size, some of the powder was rigorously mixed with canola oil, and a few drops of the dispersion were placed on the grindometer.

For the preparation of the comparative example, 30 grams of this extra fine sugar were rigorously mixed with 20 grams of a molten cocoa butter, and then mixed with 90 grams of cocoa mass to produce 140 grams of 79% dark chocolate.

The resulting chocolate had a powdery texture, with particle size of about 45 microns.

Notably, in addition to the inferior product, reducing the size of the sugar particles without the cocoa butter to a size below 40 μm results in a hygroscopic powder that cannot be used, commercially. Without being bound thereto, it appears that the refining of the cocoa butter with the sugar, in fact, protects the sugar from the undesired absorbance of water.

1. A chocolate making base unit comprising, refined together, at least one of: i) an edible fat selected from cocoa butter or ii) cocoa butter alternative and a sweetener,
wherein the sweetener is in a particulate form, and
wherein the chocolate making base unit is free of cocoa solids and milk.

2. The chocolate making base unit of claim 1, wherein the sweetener in particulate form is defined by a size distribution of d90 below 50 μm.

3. (canceled)

4. (canceled)

5. (canceled)

6. The chocolate making base unit of claim 1, being essentially free of water.

7. The chocolate making base unit of claim 1, comprising an emulsifier.

8. The chocolate making base unit of claim 1 consisting essentially of cocoa butter, a sweetener and optionally an emulsifier.

9. (canceled)

10. (canceled)

11. (canceled)

12. A method of preparing a chocolate making base unit, the method comprises refining a mixture comprising:
(a) an edible fat selected from cocoa butter and cocoa butter alternative and
(b) a sweetener in particulate form; to obtain a homogenous molten comprising the edible fat and said sweetener;
with the proviso that the mixture is free of cocoa solids and milk.

13. The method of claim 12, wherein said refining is under conditions that cause the sweetener to reduce in size.

14. The method of claim 12, wherein said refining is under conditions that provide said base unit with particulate matter having a size distribution of d90 of 40 μm.

15. The method of claim 12, wherein said mixture comprises cocoa butter and the sweetener and optionally an emulsifier.

16. (canceled)

17. (canceled)

18. The method of claim 12, comprising tempering the homogenous molten before solidification.

19. (canceled)

20. The method of claim 12, comprising molding the homogenous molten before cooling to form a shaped chocolate making base unit.

21. A method of preparing personalized chocolate product, the method comprises:
(a) providing two or more chocolate making units, at least one being a chocolate making base unit, and at least one chocolate making supplementary unit of a user's choice, the supplementary unit being different from the chocolate making base unit;
wherein the chocolate making base unit comprising, refined together, at least one of: i) an edible fat selected from cocoa butter and/or ii) cocoa butter alternative and a sweetener,
wherein the sweetener is in a particulate form, and
wherein the chocolate making base unit is free of cocoa solids and milk;
(b) melting a mixture of said chocolate making base unit and said chocolate making supplementary unit to form a chocolate molten; and,
(c) cooling said molten to form said personalized chocolate product.

22. The method of claim 21, wherein said chocolate making supplementary unit comprises cocoa butter and a chocolate making ingredient that is other than the sweetener in the chocolate making base unit.

23. (canceled)

24. The method of claim 21, wherein said chocolate molten mixture is tempered prior to solidification.

25. The method of claim 21, wherein the melting comprises heating while mixing the mixture.

26. The method of claim 21, comprising molding the molten before cooling or cooling the molten within a mold.

27. (canceled)

28. (canceled)

29. (canceled)

30. (canceled)

31. (canceled)
